(19) United States
(12) Patent Application Publication
(10) Pub. No.: US 2012/0042831 A1
(43) Pub. Date: Feb. 23, 2012

(54) SYSTEM AND RELATED METHOD FOR FEEDING BULK FOOD ITEMS TO DEER OR THE LIKE

(75) Inventors: TIM HOLLOWAY, Roaring River, NC (US); STEVE WILSON, Ronda, NC (US); RICKY WILSON, North Wilkesboro, NC (US); TROY HARTMAN, Concord, NC (US)

(73) Assignee: H&W PRODUCTS, INC., Jonesville, NC (US)

(21) Appl. No.: 13/198,146

(22) Filed: Aug. 4, 2011

Related U.S. Application Data
(60) Provisional application No. 61/375,362, filed on Aug. 20, 2010.

(51) Int. Cl. A01K 5/02

(52) U.S. Cl. 119/51.11; 119/51.01

(57) ABSTRACT

The present invention relates generally to a system and related method for feeding bulk food items to deer or the like. More specifically, the present invention relates to a system and related method for feeding bulk food items to deer or the like that includes a vertically-oriented, linearly-actuated feeding mechanism that is operated in conjunction with a timing mechanism, as well as an environmentally-protected housing. The present invention finds particular applicability in hunting and naturalist activities, for example, in which it may be desirable to attract deer or other wildlife via the feeding of apples, corn, pellets, or the like in a controlled manner over a period of time, such that the habits of these animals may be affected. Other suitable applications are certainly contemplated herein.

### CROSS-REFERENCE TO RELATED APPLICATION

The present patent application/patent claims the benefit of priority of U.S. Provisional Patent Application No. 61/375,362, filed on Aug. 20, 2010, and entitled “SYSTEM AND RELATED METHOD FOR FEEDING BULK FOOD ITEMS TO DEER OR THE LIKE,” the contents of which are incorporated in full by reference herein.

### FIELD OF THE INVENTION

The present invention relates generally to a system and related method for feeding bulk food items to deer or the like. More specifically, the present invention relates to a system and related method for feeding bulk food items to deer or the like that includes a vertically-oriented, linearly-actuated feeding mechanism that is operated in conjunction with a timing mechanism, as well as an environmentally-protected housing. The present invention finds particular applicability in hunting and naturalist activities, for example, in which it may be desirable to attract deer or other wildlife via the feeding of apples, corn, pellets, or the like in a controlled manner over a period of time, such that the habits of these animals may be affected. Other suitable applications are certainly contemplated herein.

### BACKGROUND OF THE INVENTION

Numerous conventional livestock feeders, deer feeders, bird feeders, and pet food dispensers are known to those of ordinary skill in the art. Most of these devices operate by gravity or in a rotary manner, and dispense, either on-demand or in a timed manner, bulk food items, pellets, or seeds to animals in proximity to the devices.

For example, U.S. Patent Application Publication No. 2006/0191486 to Mishler (not necessarily pre-dating the present invention—now abandoned) discloses an animal feeder that is capable of dispensing bulky feed items at regularly-timed intervals. The feeder is useful for attracting wildlife for hunting or recreational photography by placing food on the ground at a regularly scheduled time when there is adequate daylight for viewing. The animal feeder is especially useful for behavioral modification of wildlife species such as the whitetail deer. The feeder dispenses bulk food items from multiple bins using, in one case, a single, moving solenoid release mechanism. This device, however, operates by gravity through the use of complex and environmentally-vulnerable sequential release mechanisms.

U.S. Patent Application Publication No. 2009/0145365 to Mahle et al. (not necessarily pre-dating the present invention) discloses a pet pantry having storage containers for pet-related equipment, accessories, medication, or other items, and also pet food storage and dispensing. The food dispensing mechanism allows for measured food dispensing, providing volume adjustment mechanisms to dispense a desired quantity of pet food. The food dispensing mechanism is a single movement handle or button dispensing the desired quantity of food. The pet pantry is also modular allowing for adjustments to a pet owner's specification. This device, however, operates manually through the use of a vertically-oriented, linearly-actuated spring mechanism that is not environmentally-hardened or suitable for dispensing larger bulk food items, i.e. it is a simple pet feeder.

Thus, what is still needed in the art is a system and related method for feeding apples, corn, pellets, or the like in a controlled manner over a period of time that includes a vertically-oriented, linearly-actuated feeding mechanism. Such advancement needs to be effective, simple, and rugged, such that it may be used for long periods of time in hunting and naturalist environments, for example.

### BRIEF SUMMARY OF THE INVENTION

In various exemplary embodiments, the present invention provides generally a system and related method for feeding bulk food items to deer or the like. More specifically, the present invention provides a system and related method for feeding bulk food items to deer or the like that includes a vertically-oriented, linearly-actuated feeding mechanism that is operated in conjunction with a timing mechanism, as well as an environmentally-protected housing. Again, the present invention finds particular applicability in hunting and naturalist activities, for example, in which it may be desirable to attract deer or other wildlife via the feeding of apples, corn, pellets, or the like in a controlled manner over a period of time, such that the habits of these animals may be affected. Other suitable applications are certainly contemplated herein.

In one exemplary embodiment, the present invention provides a system for feeding bulk food items to deer or the like, including: a housing configured to hold the bulk food items; a linear actuation mechanism disposed at least partially within the housing; and a plate structure disposed within the housing and coupled to the linear actuation mechanism; wherein, when the linear actuation mechanism is deployed vertically within the housing, the plate structure expels a portion of the bulk food items out of a top portion of the housing. The system also includes a timer controller coupled to the linear actuation mechanism. The system further includes an environmental protection cover disposed about the top portion of the housing. The linear actuation mechanism is at least partially disposed within a secondary housing coupled to the housing. The linear actuation mechanism is deployed vertically within the housing by one of translation and rotation. The system still further includes a plurality of legs coupled to the housing and configured to hold the housing off of the ground. Optionally, the plurality of legs are telescoping.

In another exemplary embodiment, the present invention provides a method for feeding bulk food items to deer or the like, including: providing a housing configured to hold the bulk food items; providing a linear actuation mechanism disposed at least partially within the housing; and providing a plate structure disposed within the housing and coupled to the linear actuation mechanism; wherein, when the linear actuation mechanism is deployed vertically within the housing, the plate structure expels a portion of the bulk food items out of a top portion of the housing. The method also includes providing a timer controller coupled to the linear actuation mechanism. The method further includes providing an environmental protection cover disposed about the top portion of the housing. The linear actuation mechanism is at least partially disposed within a secondary housing coupled to the housing. The linear actuation mechanism is deployed vertically within the housing by one of translation and rotation. The method still further includes providing a plurality of legs coupled to the housing and configured to hold the housing off of the ground. Optionally, the plurality of legs are telescoping.

In a further exemplary embodiment, the present invention provides a system for feeding bulk food items to deer or the like, including: a housing configured to hold the bulk food items; an environmental protection cover disposed about a top portion of the housing; a linear actuation mechanism disposed at least partially within the housing; and a plate structure disposed within the housing and coupled to the linear actuation mechanism; wherein, when the linear actuation mechanism is deployed vertically within the housing, the plate structure expels a portion of the bulk food items out of the top portion of the housing, between a wall of the housing and the environmental protection cover. The system also includes a timer controller coupled to the linear actuation mechanism. The linear actuation mechanism is at least partially disposed within a secondary housing coupled to the housing. The linear actuation mechanism is deployed vertically within the housing by one of translation and rotation. The system further includes a plurality of legs coupled to the housing and configured to hold the housing off of the ground. Optionally, the plurality of legs are telescoping.

### BRIEF DESCRIPTION OF THE DRAWINGS

The present invention is illustrated and described herein with reference to the various drawings, in which like reference numbers are used to denote like system components/method steps, as appropriate, and in which:

FIG. 1 is a planar schematic view illustrating one exemplary embodiment of the feeder system of the present invention;

FIG. 2 is another planar schematic view illustrating a portion of one exemplary embodiment of the feeder system of the present invention;

FIG. 3 is a further planar schematic view illustrating a portion of one exemplary embodiment of the feeder system of the present invention; and

FIG. 4 is a still further planar schematic view illustrating a portion of one exemplary embodiment of the vertically-oriented linear actuation mechanism of the feeder system of the present invention.

### DETAILED DESCRIPTION OF THE INVENTION

In various exemplary embodiments, the present invention provides generally a system and related method for feeding bulk food items to deer or the like. More specifically, the present invention provides a system and related method for feeding bulk food items to deer or the like that includes a vertically-oriented, linearly-actuated feeding mechanism that is operated in conjunction with a timing mechanism, as well as an environmentally-protected housing. Again, the present invention finds particular applicability in hunting and naturalist activities, for example, in which it may be desirable to attract deer or other wildlife via the feeding of apples, corn, pellets, or the like in a controlled manner over a period of time, such that the habits of these animals may be affected. Other suitable applications are certainly contemplated herein.

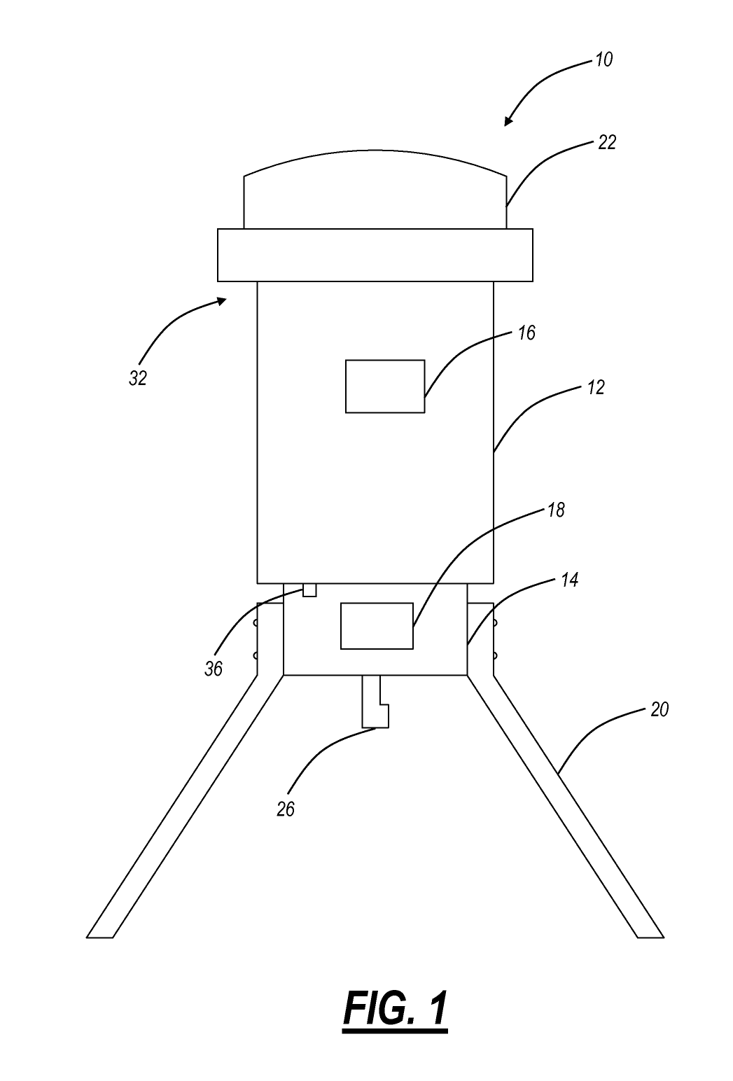

Referring to FIG. 1, in one exemplary embodiment of the present invention, the feeder system 10 includes a substantially-cylindrical main housing 12 having dimensions on the order of 15 inches in height by 14 inches in diameter, although other suitable shapes and dimensions may be utilized depending upon manufacturing preferences and the type of feed utilized, and a substantially-cylindrical secondary housing 14 having dimensions on the order of 10 inches in height by 12 inches in diameter, although other suitable shapes and dimensions may be utilized depending upon manufacturing preferences and the type of feed utilized. Both the main housing 12 and the secondary housing 14, which may alternatively be integrally formed and/or co-extensive or separately formed and/or non-coextensive, are manufactured from a formed metallic material, a molded plastic material, or the like that is environmentally rugged and that provides an attractive appearance to the feeder system 10. Upon assembly and use, the main housing 12 houses the electronic and mechanical components of the feeder system 10, as well as bulk food items that are to be deployed, while the secondary housing 14 houses the electronic and mechanical components of the feeder system 10. Accordingly, the main housing 12 includes one or more indicia plates or labels 16 and the secondary housing 14 includes one or more access panels 18. The top portion of the main housing 12 is open for the selective addition and expulsion of the bulk food items.

A plurality of tubular legs 20 or an equivalent support structure are attached to the main housing 12 and/or secondary housing 14 in order to hold the main housing 12 and the secondary housing 14 in a substantially vertical orientation with respect to the ground on which the feeder system 10 is placed. In the exemplary embodiment illustrated, three tubular legs 20 are used and are equally spaced about the secondary housing 14, to which they are bolted, for example. The plurality of tubular legs 20 each typically have a length on the order of 40 inches, although any suitable length may be used, such that the feeder system 10 sits a desired distance above the ground. This distance may affect the coverage radius of expelled feed. Of course, a plurality of adjustable tubular legs 20 may also be utilized.

Additionally, protective cover 22 is selectively attached to the top portion of the main housing 12, protecting the contents thereof from rain, the elements, and unwanted animal intrusion. In the exemplary embodiment illustrated, the protective cover 22 is substantially cylindrical and dome like with dimensions on the order of 13 inches in height by 24 inches in diameter, although other suitable shapes and dimensions may be utilized based on manufacturing preferences, desired functionality, desired appearance, etc. The protective cover 22 is manufactured from a formed metallic material, a molded plastic material, or the like that is environmentally rugged and that provides an attractive appearance to the feeder system 10.

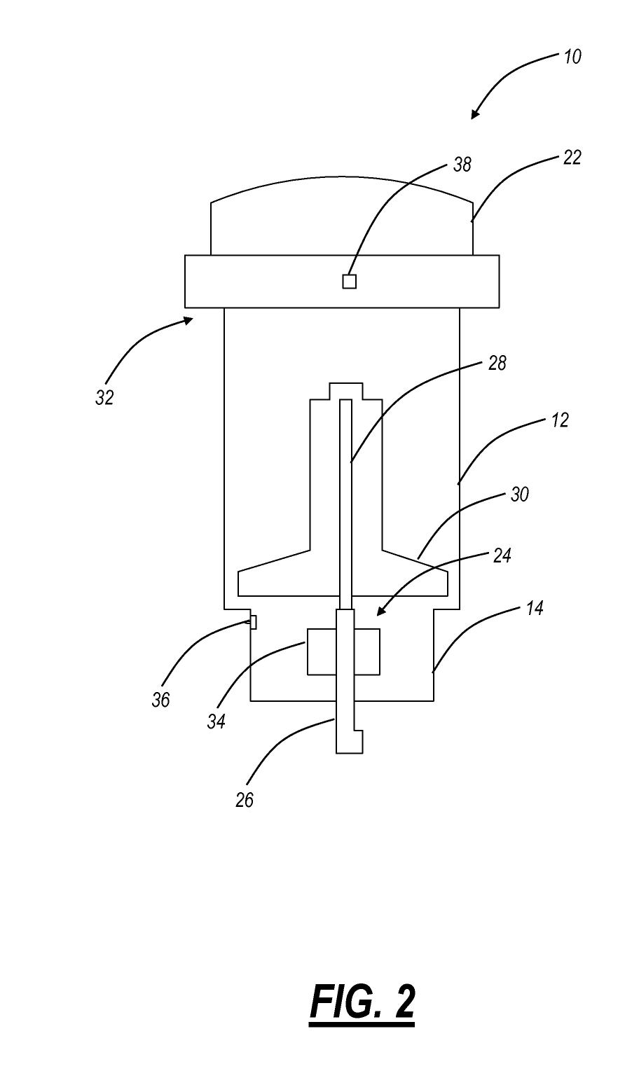

Referring to FIG. 2, in one exemplary embodiment of the present invention, the feeder system 10 also includes a vertically-oriented linear actuation mechanism 24 disposed within the main housing 12 and secondary housing 14. The linear actuation mechanism 24 includes an actuator housing 26 within which an extensible shaft 28 is partially disposed. The shaft 28 is selectively actuated to deploy a bulk food item delivery plate 30 vertically along the height of the main housing 12. When deployed, this delivery plate 30 pushes a predetermined quantity of the bulk food items upwards and over the top edge of the main housing 12, through a vent 32 formed between the top edge of the main housing 12 and the protective cover 22 or through other suitable ports or openings manufactured into the top portion of the main housing 12 and/or side portion(s) of the protective cover 22. Accordingly, the linear actuation mechanism 24 has a stroke length that is on the order of 24 inches, for example. Deployment is governed by a programmable timer mechanism 34 (e.g. a 12-V programmable timer mechanism) and/or any number or controllers/circuits, user interfaces, etc. A switch mechanism 36 (e.g. a 6-pole switch mechanism) is provided to turn the feeder device 10 on/off or place it in any number of predetermined modes of operation, such as a pre-programmed timed feed mode of operation, a programmed timed feed mode of operation, a manual mode of operation, etc.

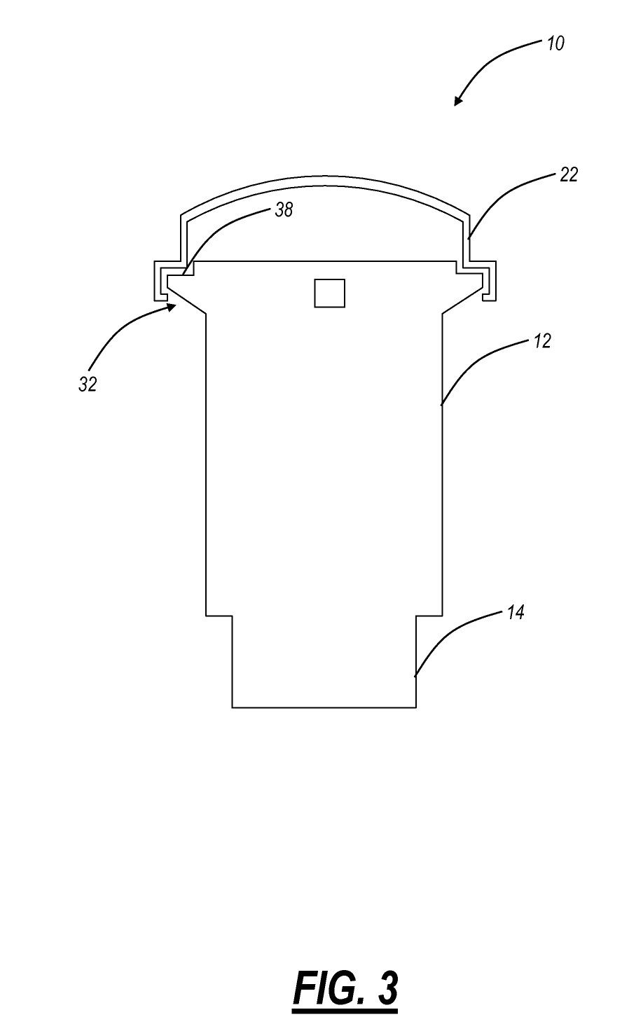

Referring to FIG. 3, in one exemplary embodiment of the present invention, the feeder system 10 further includes a plurality of latches, ridges, struts, trusses, or other mechanical structures/mechanisms 38 for selectively securing the protective cover 22 to the top portion of the main housing 12, while maintaining the vent 32 formed between the top edge of the main housing 12 and the protective cover 22. For example, these retention structures 38 may engage corresponding structures disposed within the protective cover 22. In the exemplary embodiment illustrated, three retention structures 38 are used and are equally spaced about the main housing 12, with which they are integrally formed or to which they are bolted, for example

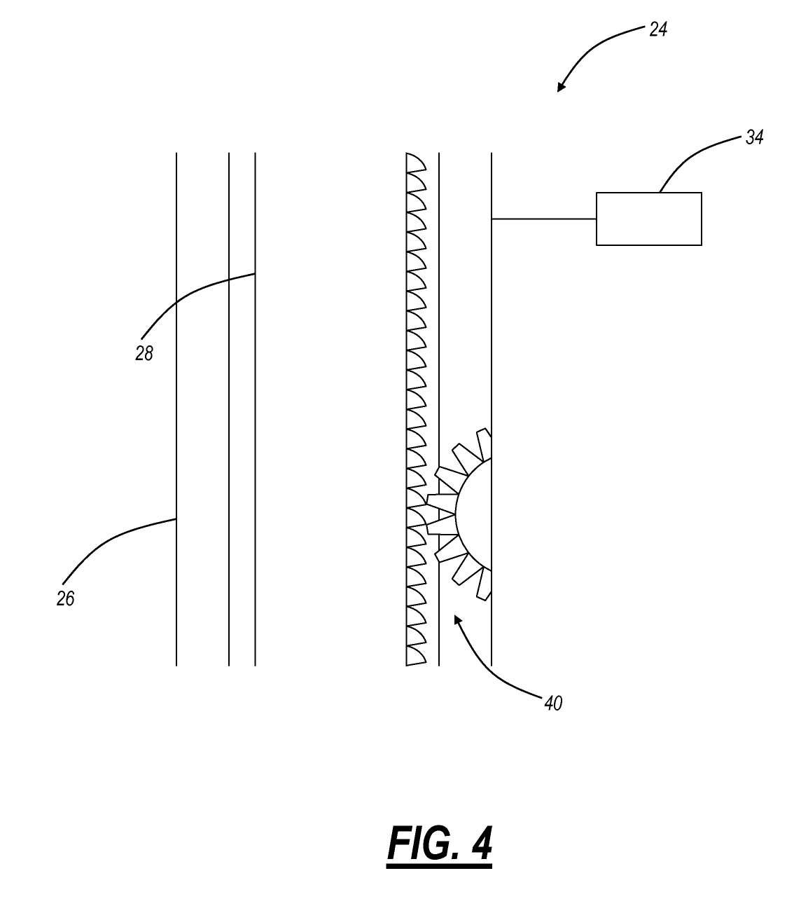

Referring to FIG. 4, in one exemplary embodiment of the present invention, the linear actuation mechanism 24 includes the actuator housing 26 within which the extensible shaft 28 is partially disposed. The shaft 28 is selectively actuated to deploy the bulk food item delivery plate 30 (FIG. 2) vertically along the height of the main housing 12 by a gear/tooth crawler mechanism 40 or the like. Alternatively, the extensible shaft 28 may be rotated and “spun up” within the actuator housing 26 to deploy the bulk food item delivery plate 30.

In operation, the feeder system 10 typically works on a seven-day cycle, pushing out 15 apples or the like twice a day, for example. Alternatively, any cycle up to a twenty-four-day cycle may be utilized, for example. Any feeding routine may be programmed, however, with the number of apples or other bulk food items being delivered during feedings being dependent upon the dimensions of the feeder system 10, the stroke length of the extensible shaft 28, etc.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1. A system for feeding bulk food items to deer or the like, comprising:
a housing configured to hold the bulk food items;
a linear actuation mechanism disposed at least partially within the housing; and
a plate structure disposed within the housing and coupled to the linear actuation mechanism;
wherein, when the linear actuation mechanism is deployed vertically within the housing, the plate structure expels a portion of the bulk food items out of a top portion of the housing.

2. The system of claim 1, further comprising a timer controller coupled to the linear actuation mechanism.

3. The system of claim 1, further comprising an environmental protection cover disposed about the top portion of the housing.

4. The system of claim 1, wherein the linear actuation mechanism is at least partially disposed within a secondary housing coupled to the housing.

5. The system of claim 1, wherein the linear actuation mechanism is deployed vertically within the housing by one of translation and rotation.

6. The system of claim 1, further comprising a plurality of legs coupled to the housing and configured to hold the housing off of the ground.

7. The system of claim 6, wherein the plurality of legs are telescoping.

8. A method for feeding bulk food items to deer or the like, comprising:
providing a housing configured to hold the bulk food items;
providing a linear actuation mechanism disposed at least partially within the housing; and
providing a plate structure disposed within the housing and coupled to the linear actuation mechanism;
wherein, when the linear actuation mechanism is deployed vertically within the housing, the plate structure expels a portion of the bulk food items out of a top portion of the housing.

9. The method of claim 8, further comprising providing a timer controller coupled to the linear actuation mechanism.

10. The method of claim 8, further comprising providing an environmental protection cover disposed about the top portion of the housing.

11. The method of claim 8, wherein the linear actuation mechanism is at least partially disposed within a secondary housing coupled to the housing.

12. The method of claim 8, wherein the linear actuation mechanism is deployed vertically within the housing by one of translation and rotation.

13. The method of claim 8, further comprising providing a plurality of legs coupled to the housing and configured to hold the housing off of the ground.

14. The method of claim 13, wherein the plurality of legs are telescoping.

15. A system for feeding bulk food items to deer or the like, comprising:
a housing configured to hold the bulk food items;
an environmental protection cover disposed about a top portion of the housing
a linear actuation mechanism disposed at least partially within the housing; and
a plate structure disposed within the housing and coupled to the linear actuation mechanism;
wherein, when the linear actuation mechanism is deployed vertically within the housing, the plate structure expels a portion of the bulk food items out of the top portion of the housing, between a wall of the housing and the environmental protection cover.

16. The system of claim 15, further comprising a timer controller coupled to the linear actuation mechanism.

17. The system of claim 15, wherein the linear actuation mechanism is at least partially disposed within a secondary housing coupled to the housing.

18. The system of claim 15, wherein the linear actuation mechanism is deployed vertically within the housing by one of translation and rotation.

19. The system of claim 15, further comprising a plurality of legs coupled to the housing and configured to hold the housing off of the ground.

20. The system of claim 19, wherein the plurality of legs are telescoping.
